(19) United States
(12) Patent Application Publication
(10) Pub. No.: US 2014/0100967 A1
(43) Pub. Date: Apr. 10, 2014

(54) SYSTEMS AND METHODS FOR AUTOMATED CHANNEL ADDITION

(71) Applicants: Scott Bedard, San Carlos, CA (US); Vince Broady, Santa Monica, CA (US); Ankarino Lara, Pasadena, CA (US); Jonathan Eccles, San Francisco, CA (US); Adam Buchen, San Francisco, CA (US)

(72) Inventors: Scott Bedard, San Carlos, CA (US); Vince Broady, Santa Monica, CA (US); Ankarino Lara, Pasadena, CA (US); Jonathan Eccles, San Francisco, CA (US); Adam Buchen, San Francisco, CA (US)

(21) Appl. No.: 13/772,305

(22) Filed: Feb. 20, 2013

Related U.S. Application Data
(63) Continuation-in-part of application No. 13/644,389, filed on Oct. 4, 2012.

(51) Int. Cl. G06Q 30/02

(52) U.S. Cl. CPC G06Q 30/0269
USPC 705/14.66

(57) ABSTRACT

The present invention relates to systems and methods for automated channel addition. A content management system receives a request for channel assessment from the channel. The request may include a JSON file. The system then scores the channel by at the number of users, topics of conversations, sentiment of the topics, and level of engagement for the users. The channel is then cataloged for access by a client (advertiser). Next the system receives approval of the channel from the client. Next the system selects content for the channel. Content selection may be in response to a channel request for particular content, in response to a client request for the particular channel, or through sentiment based matching. After content selection it may be published to the channel. This publishing uses the JSON file to modify the content to be compatible with the channel application programming interface.

### CROSS REFERENCE TO RELATED APPLICATIONS

This application claims priority to U.S. patent application Ser. No. 13/644,389, by Bedard et al., entitled “Systems and Methods for Automated Reprogramming of Displayed Content”, filed on Oct. 4, 2012.

### BACKGROUND

The present invention relates to systems and methods for automated channel additions. Such systems and methods are particularly useful in the context of online activities, and may be especially useful in social media and advertising. Such systems and methods enable advertisers to make their ads more accessible to users, and to better maximize online advertisement real estate.

For most online networks an advertisement needs to comply with specific and proprietary Application Programming Interface (API) of that network. This is true for most social media networks, as well as for other online websites that support advertisements. Often, the process of making a marketing platform compatible with these networks requires extensive manual activity. This causes the marketing platform to only be usable with a few networks without considerable resources being expended.

In the past, this limitation was not particularly problematic because there were relatively few networks being actively pursued by advertisers. However, as the field advances, manufacturers and retailers are increasingly recognizing the value of online advertising. And further, the number of vertical social networks, and other online destinations, are increasing rapidly. As such, there are greater numbers of advertisers interested in placing ads on an ever increasing number of networks. Thus the divergent APIs required for each network poses a significant scaling hurdle to advertisers.

In order to address this issue, there has been a push for a uniform access protocol that would allow third party advertisers to access multiple networks through a single API. However, the various networks have been, and continue to be, resistant to adopting a uniform access protocol.

Another attempt to make websites more accessible to advertisers was attempted by Google through the deployment of its Social Data Hub. This service invited social networks to join its service in order to make their network data available to Google advertisers.

In Google's service, the social media sites will provide content (as an Atom XML file) to the Hub, after which Google reviews the content, and sends technical details back to the social media sites for integration with the Hub. After integration, any activity posted on the social media site is pushed out to the Hub for consumption by marketing analytics and advertisers. While this does not address an advertisers need to publish their advertisements on more networks, it does enable them to gather additional marketing analytics.

As such, today advertisers are still forced to manually integrate their marketing platforms into websites, or leverage ad services provided by each individual network. This is highly inefficient, and prevents widespread rollout of a marketing platform without considerable resource investment.

It is therefore apparent that an urgent need exists for systems and methods for automated channel additions. Such systems and methods would be able to provide advertisers the ability to publish marketing platforms on a wide range of networks readily and efficiently.

### SUMMARY

To achieve the foregoing and in accordance with the present invention, systems and methods for automated channel addition are provided. Such systems and methods enable advertisers to access a much wider variety and larger number of channels, such as social networks, without significant resource expenditure. Likewise, such systems and methods enable social networks, or other channels, to access a wide variety of content (both advertisements and other marketing content) which may be of interest to the users of the channel.

In some embodiments, a content management system receives a request for channel assessment from the channel. The request may include a JSON or Atom XML file, or any other data type for transferring data. The system then scores the channel by at the number of users, topics of conversations, sentiment of the topics, and level of engagement for the users. This may be a composite score, or a score across different topic sectors. The channel is then cataloged for access by a client (advertiser).

Next the system receives approval of the channel from the client. Next the system selects content for the channel. Content selection may be in response to a channel request for particular content, in response to a client request for the particular channel, or through sentiment based matching. For sentiment based selection, the system identifies a desired result, accesses a psychological profile that includes a persistent user identification, and selects content by maximizing probabilities of the desired result occurring based upon the psychological profile. The persistent user identification enables access to the psychological profile across any number of channels, and may take the form of a cookie stored locally with the user.

After content selection it may be published to the channel. This publishing uses the JSON or Atom XML file to modify the content to be compatible with the channel application programming interface.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is an example functional block diagram illustrating users engaging a content management system capable of automated channel addition, and advertisement networks, in accordance with some embodiments;

FIG. 2 is an example block diagram for the content management system which includes an automated channel addition element, in accordance with some embodiments;

FIG. 3 is an example flow chart for the process of a automatically adding a channel, in accordance with some embodiments;

FIG. 4 is an is an example flow chart for the sub-process of content selection, in accordance with some embodiments;

FIG. 5 is an example flow chart for selecting the best content for the specific user, in accordance with some embodiments;

FIG. 6 is an example flow chart for feedback analysis, in accordance with some embodiments;

FIG. 7 is an example diagram for a template form which channels complete in order to gain compatibility with the automated channel addition, in accordance with some embodiments;

FIG. 8 is an example screenshot of a social network site, in accordance with some embodiments; and

FIGS. 9A and 9B are example illustrations for computer systems configured to embody the content management system capable of automated channel addition, in accordance with some embodiments.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

The present invention relates to a novel means, systems and methods for adding channels in an automated manner. These systems and methods may be particularly useful within social media settings, where user data is rich, but may be extended to any suitable platform. Additionally, the following systems and methods enable an advertiser to roll out an advertisement to multiple websites, despite them having different Application Programming Interfaces (APIs).

Note that while much of the discussion contained herein relates to social networks providing content to the users, it is entirely possible that any content provider may utilize the disclosed systems and methods. For example, media sources, such as YouTube, news outlets, such as CNN online, and online retailers, such as Amazon, may all be considered “content providers” or “distribution channels” for the purposes of this disclosure. Further, advertisers may likewise be referred to as “ad providers”.

Lastly, while the term “content” is commonly utilized in this disclosure to mean advertisements, promotions, marketing platforms, or offers (monetization vehicles) it is entirely possible that content may include non-advertisement content. It may be desirable to capture the user's interest for as long as possible, since many websites are valued based upon user traffic. By tailoring content displayed upon the website to the user, and making advertisements interactive, they may spend more time on the particular site without the desire to navigate away from the content provider.

The following description of some embodiments will be provided in relation to numerous subsections. The use of subsections, with headings, is intended to provide greater clarity and structure to the present invention. In no way are the subsections intended to limit or constrain the disclosure contained therein. Thus, disclosures in any one section are intended to apply to all other sections, as is applicable.

### I. Automated Channel Addition System

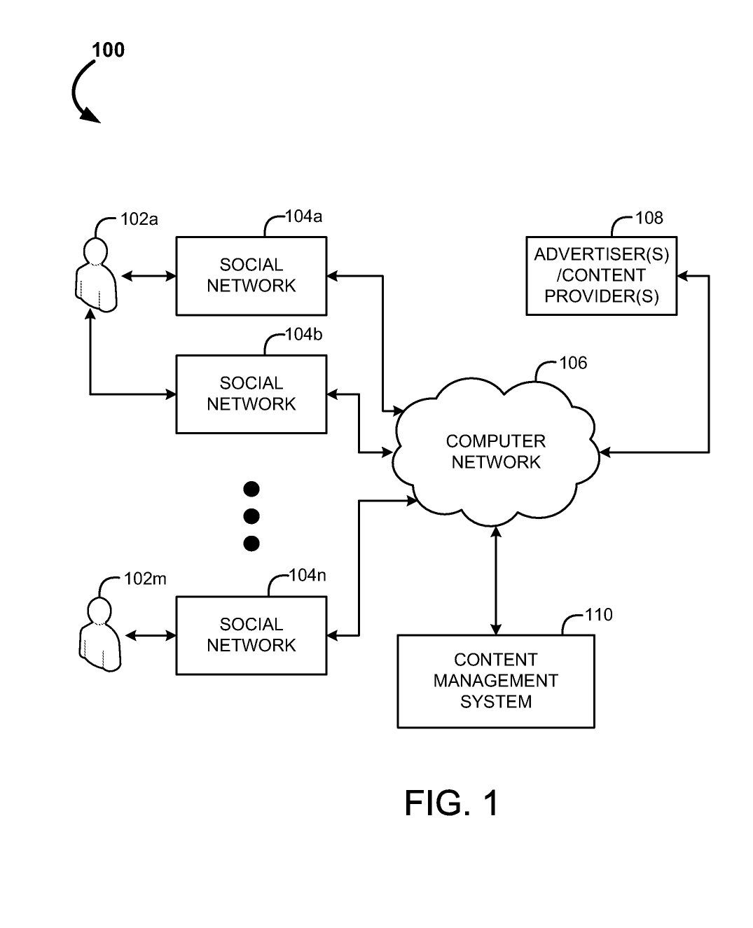

To facilitate the discussion, FIG. 1 is an example functional block diagram 100 illustrating users 102a to 102m engaging social networks 104a to 104n in conjunction with a content management system 110 to tailor the content displayed, and deliver interactive advertisements. In this particular example illustration, two users 102a to 102m are seen interacting with one or more social networks (channels) 104a to 104n. While social networks 104a to 104n are illustrated in this example illustration, it is considered within the scope of this disclosure that a wide variety of websites may be accessed by the users 102a to 102m, including entertainment sites, news outlets, retailers, search engines, blogs, informational and reference pages, websites for organizations, social media sites, branded websites, or any other distribution channel accessible by a user.

The social networks 104a to 104n are accessed by the users 102a to 102m via a computer network 106. In some embodiments, the computer network 106 is the internet; however, it is possible that the computer network 106 may include any wide area network, local area network, company network, interactive television network, etc. The computer network 106 additionally couples the social networks 104a to 104n to a content management system 110 and advertisement network(s)/content providers 108.

The advertisement network(s) 108 may provide content (advertisements, marketing platforms, etc.) to the content management system 110. The social networks 104a to 104n provide a form providing the content management system 110 the resources necessary to tailor the content to each specific API for each social network 104a to 104n. Thus, the advertiser 108 is only required to provide one set of data to a single recipient in order to roll out advertisements to a wide number of channels.

In some embodiments, a user 102a may access a social network 104a. The social network 104a provides the content that has been tailored by the content management system 110 to the user 102a. In some cases, the content provided to the user 102a may not only be tailored to the API of the social network, but may even be selected by the content management system 110 from a variety of possible content. In these particular embodiments, the content management system 110 operates in the background to analyze the sentiments of the user 102a to determine what content will be provided to the user. In these embodiments, the content management system 110 is capable of tying each user 102a to a persistent identification, and is linked to the user's 102a identification in each social network they frequent. This persistent identification allows the sentiment of the user 102a to be tracked across various social networks 104a to 104n (or other social networks). This enables the content management system 110 to learn about the user 102a, develop a personality profile, and make more exact predictions regarding how the user 102a will react to any particular content.

In addition, the content management system 110 may access data generated by users on the social network. This feedback data on these channels may be tracked by the content management system 110 and utilized for further operations, such as distributed engagement channel development, improving content selection, and user analytics. This feedback data may be the number of “likes” for example, number of “shares”, and comments by users.

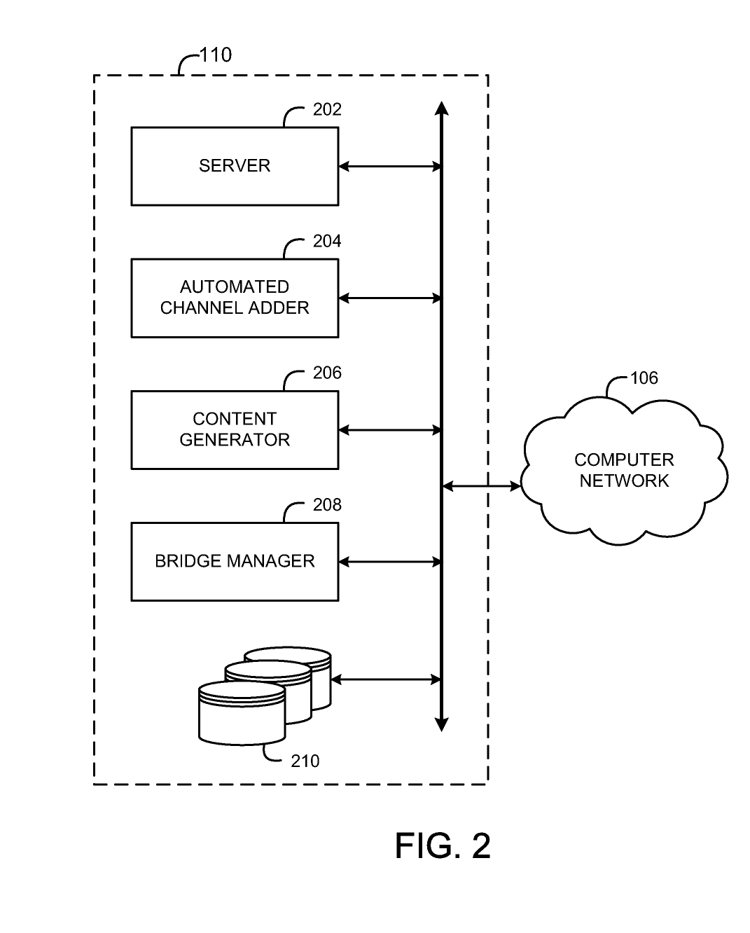

FIG. 2 is an example block diagram for the content management system 110, in accordance with some embodiments. The content management system 110 includes a server 202, an automated channel adder 204, a content generator 206, an interactive bridge manager 208, and one or more database 210. Each of these subsystems is a logical component of the content management system 110 and is logically coupled to one another. In cases in which these subsystems are embodied upon a single device, or operating within a cloud environment, the coupling may be merely logical in nature. When these subsystems are embodied within separate devices, the coupling may include a physical connection, such as a central bus.

Each component of the content management system 110 may likewise access the computer network 106. The server 202 may interact directly with the social networks 104a to 104n (or other channels) in order to provide the content selection for a given user 102a, as well as interact with the advertisers 108.

The interactive bridge manager 208, which is optional depending upon embodiment, may generate an interactive bridge button for inclusion in the advertisements, which distributed engagement channels they link with, and which content (comments, live stats, etc.) they pull from. In some embodiments, the generated interactive bridge button may even include live statistics or other personalized content for the user. Likewise, the content generator 206 may utilize content to optimize it for each social network as will be discussed in greater detail. An interactive bridge manager 208 and content generator 206 may improve the quality of content provided to the social networks for consumption by the user. It should be noted however, that while these quality improving functions improve user engagement; they are not required to perform automated channel addition in some embodiments.

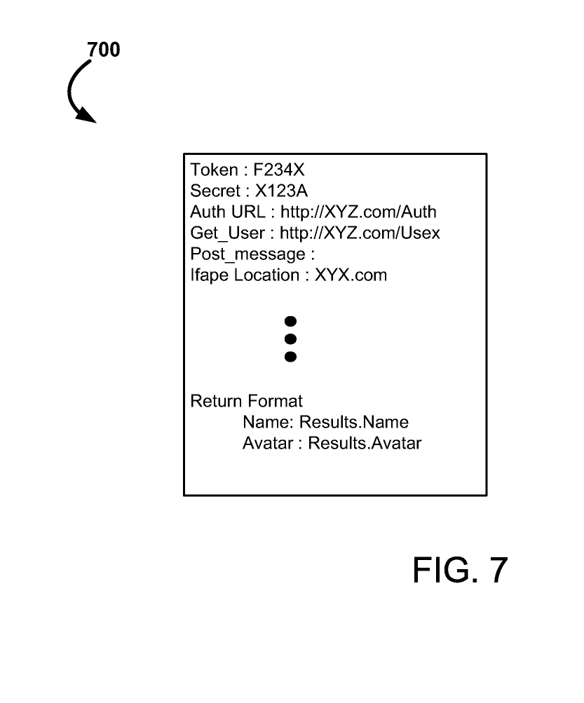

The automated channel adder 204 receives form data from the social networks 104a to 104n. An example of the form data received may be seen in relation to FIG. 7, at 700. The form data includes a token, secret, authentication url, API endpoints to get a user or other entity's info, optional extra data schema, and SLA relating to rate-limiting or other performance-affecting factors. The automated channel adder 204 can utilize the form data for configure the advertisers content to be compatible with each of the social networks APIs. Thus, the automated channel adder 204 may generate multiple versions of the advertiser's 108 content which can be added to any supported channel in an automated fashion.

Although not shown, the content generator 204 may be employed by a sentiment analyzer in order to generate probabilities that the given user 102a will react positively to a given piece of content. The profiles, available content and social network API requirements (form data) may be stored within a database 210.

### II. Channel Addition Process

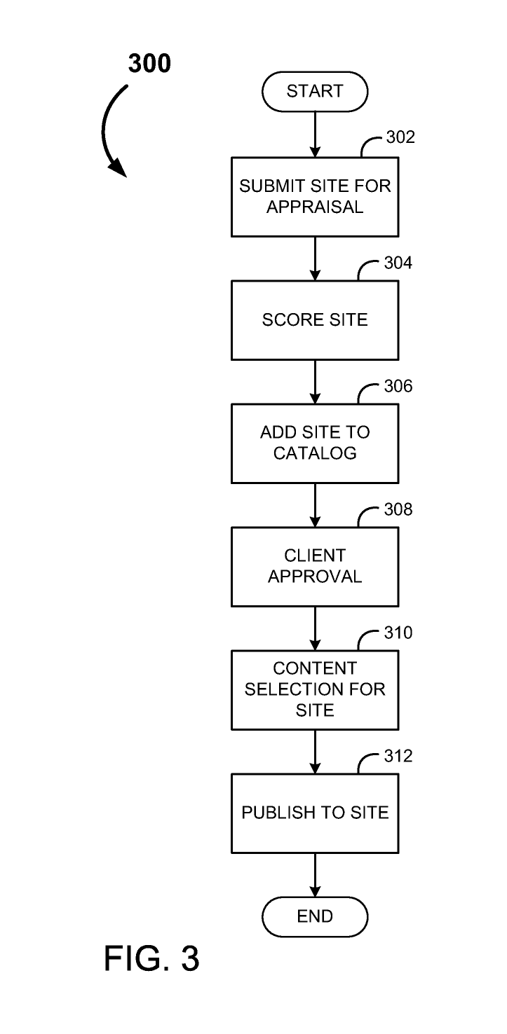

FIG. 3 is an example flow chart 300 for the process of an advertiser engaging with a content management system for automated channel addition, in accordance with some embodiments. In this process a social network (or other channel) may access the content management system. The site is submitted for appraisal by the content management system (at 302). Site submission may include providing the form data, as previously discussed in relation with FIG. 7. The form data may include an Atom XML file or equivalent. This form data is similar to existing procedures employed by Google's Hub, and as such is something social networks are already doing, thereby promoting adoption or buy-in of the presently disclosed system.

Generally the channel seeks out the content management system in order to submit their site for assessment. However, in some cases the channel may not be aware of the system. In those cases, the system could, periodically, automatically scrape the web looking for new channels. Upon finding a new one, the system could invite the new channel to submit a form per the above described step.

Next the content management system scores the site (at 304). Site scoring is not presently performed by any other system currently, as disclosed, for the automated addition of channels for advertisement distribution. Site scoring includes cataloging each participating channel (social network, etc.), and generates a score values for each site based upon the number of users, topics of conversation, sentiments on these topics, and level of user engagement. These scores may be a single composite value of the site, or may be scored in various categories. For example, a site for technophiles may have a relatively small user base, and a narrow scope of topics, but the sentiments may be high regarding this topic and its users very active. As such, an overall value score would be low, but a value score in the area of high-end technology may be high. This scoring process provides guidance to advertisers which channels they are of most value to the specific advertiser. One such scoring algorithm would be: [(proportionate change in monthly active users)/sqrt([domain variety score]/[monthly active users])]*(# of users of that channel on DEC/total # users across all DEC platform).

After site scoring, the site and score are added to a catalog (at 304) for rapid and easy access. Next, the scored and cataloged social network site (or other channel) is presented to the advertiser client for approval. This approval may proceed in alternative ways, depending upon embodiment.

In some embodiments, a social network desires to join the marketing platform's delivery system without requesting specific advertising content. In that scenario, the content management system performs a matching function that matches certain social networks with certain advertisers depending on matching criteria.

From the advertiser point of view, these additional social networks may appear as additional possible channels for their content, beyond the main channels of Facebook, YouTube, etc. The advertiser's approval of the new social network can occur, for example, when the advertiser selects that social network as a channel for advertising.

In some other embodiments, the social network is interested in particular content of the advertiser handled by the content management system. For example, the users of the social network might be talking about a particular movie for which the content management system has advertising content for.

In that case, the social network can request that particular content of that advertiser in the form of the first step above. That request is presented to the advertiser which then can accept or reject the request.

Once the advertiser (client) approves the display of content on the social network, the system may select which content is to be advertised on the site (at 310). In some cases, a particular advertisement may be pushed by the advertiser, or requested by the channel, in which case these desires may influence the content selection. Alternatively, in some cases a very limited set of advertisements may be available. In this case, the selection step may be trivial. However, in circumstances where a number of advertisements (or other content) are available for publishing on the channel, it may be desirable to perform improved sentiment driven content selection in order to improve the impact of the published content.

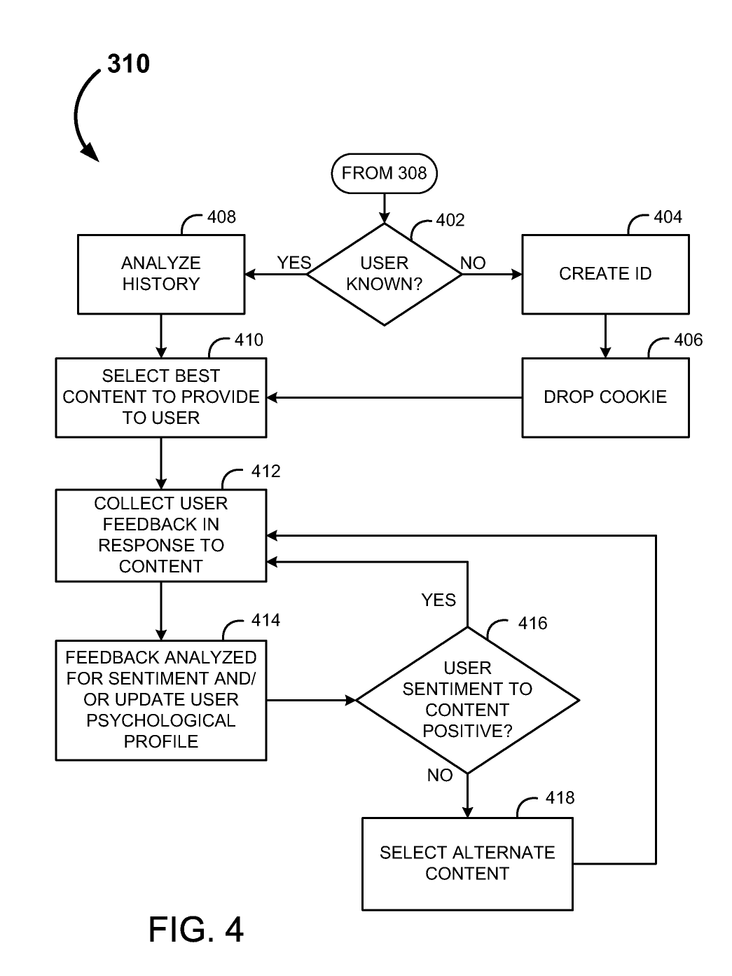

FIG. 4 provides an example process of generating tailored content for a user by based upon user sentiment (at 310). In this example process, initially a decision is made whether the user accessing the content provider is known (at 402). Users are “known” when they can be tied to a psychological profile. The content selection component of the content management system may identify tracking cookies upon the user's computer (or other computational device, such as tablets, mobile devices, etc.). If no identifying cookie exists, some embodiments of the automated reprogramming system may alternatively identify the user by device MAC address or other indication. In some embodiments, the user is known if she is logged into the social network (or other channel). For example, a user must supply a password and username to access their profile in Facebook or Twitter. The channel can use this authentication process in order to inform the content management system of the user's identity. By leveraging both login data and cookies, the content management system may be able to track users even when they are using different devices, and across different unrelated websites.

If the user is known, the user's history is analyzed (at 408). History analysis may include accessing the user's psychological profile from storage. Alternatively, if the user is not known, an ID may be generated for the user (at 404) which is associated with a new user psychological profile. The new psychological profile may be blank initially, or may include one of potentially several default profiles based upon “stereotypical” users that access the content provider, or otherwise based upon the user's activity. After the user ID is generated, the automated reprogramming system may drop a cookie (at 406) in order to facilitate tracking the user across various content providers (such as Twitter and Facebook, for example).

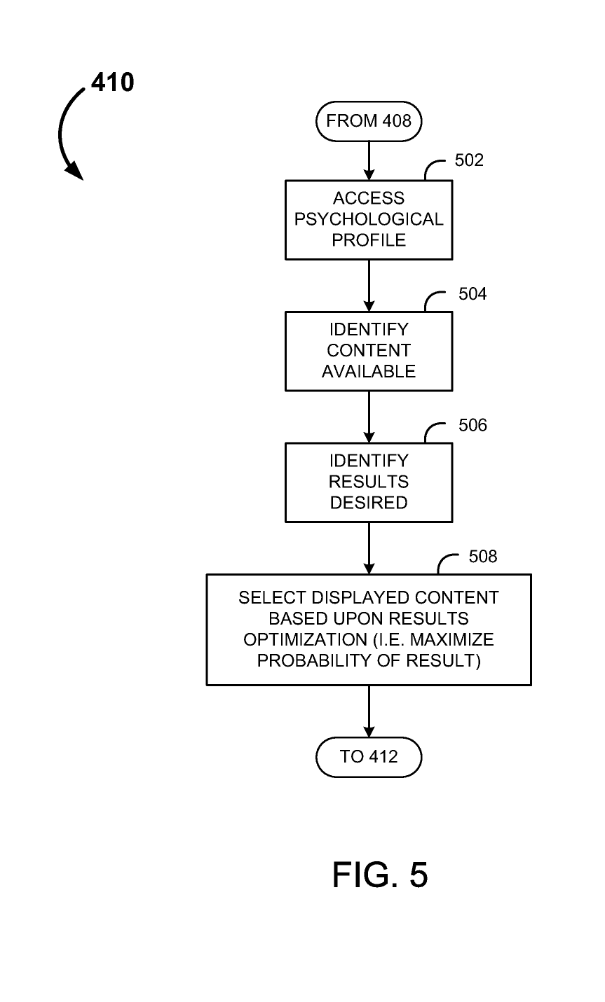

Once the psychological profile has been retrieved from storage (or newly generated), the system selects the best content to provide to the user (at 410). Turning to FIG. 5, an example flow chart for this sub process of content selection is illustrated. This process accesses the user's psychological profile (at 502). The psychological profile may include any number of variables that can be utilized to model user response to content. Typically, a psychological profile may include sentiments, interests, demographics, state of mind, habits, and networks, for example. Sentiments may indicate an overall personality such as “negative”, or “optimistic”. Interests may include topics the user is interested in, such as “movies”, “fashion” or “food”. Demographics may include information such as age, race, gender, and socioeconomics. State of mind may include overarching themes the user is involved in, such as “getting married”, “having a baby”, “buying a house” or other such life events that are persistently impacting the user. Habits may include behavioral habits such as being a “purchaser” or “sharer”. Network may include the user's friend lists and other contacts.

The system also queries the database for the content that is available for display to the user (at 504). The desired result is then determined by the system (at 506). The desired result, in the case of an advertisement, may include the user clicking upon the ad, or accessing the website that the advertisement is promoting. If the content is non-advertisement material, the desired result may include staying longer on the webpage, or exploring the content in greater detail. Other desirable results may include sharing of the content, making a purchase, broadcasting the content, or building up reputation of the content (typically through positive comments).

Once the system identifies which result is desired, it then models the probability of that result occurring for each of the available content based upon the user profile (at 508). This modeling may compare how other users with similar psychological profiles reacted to the content in order to build a probability function where each category in the psychological profile is a variable. The system may then optimize for the largest probability of the result occurring, given the available content. The identified content may be selected for display. In some embodiments, vector similarity may be employed to match the user profile to content. Content may be recommended via user-item collaborative filtering. Recommendations obtained from both content similarity and collaborative filtering may then be ranked using weights calculated from feedback and displayed to user, in some embodiments. Users may also be matched to one another using vector similarity, or comparable analytic techniques.

Returning to FIG. 4, once the content has been selected and displayed, the system collects feedback from the user (at 412) in response to the content. This feedback may include a comment, a desired result, or some other action by the user. The feedback may be analyzed for sentiment and the user's psychological profile may be updated (at 414).

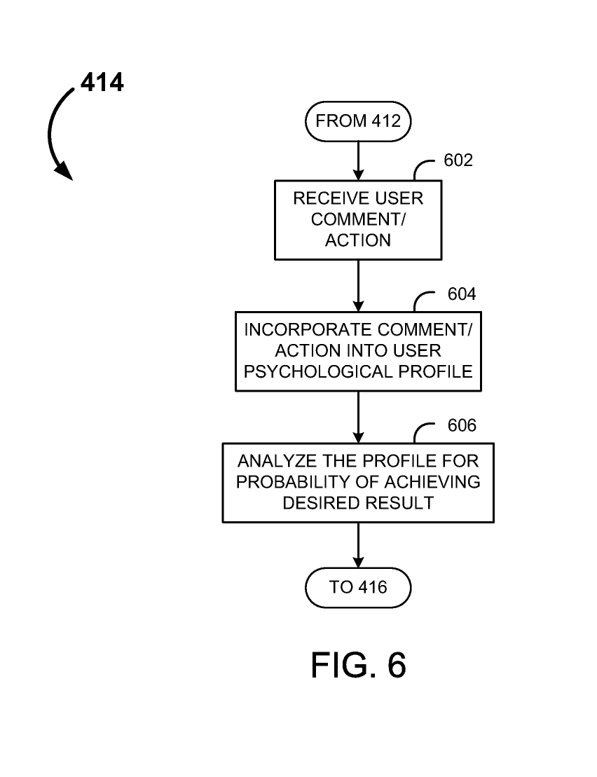

Turning now to FIG. 6, an example flow chart for the process of feedback analysis is illustrated. In this example process, the user's comment or action is received (at 602), and the comment or action is incorporated into the user psychological profile (at 604). For example, assume the user provides feedback to content including a comment of “Stop testing on animals”. The system may parse the comment, and perform syntactical analysis on the parsed comment. Based upon the analysis, the system may determine that changing the content is appropriate. It may also be possible that the comment may be analyzed for factual accuracy, and if inaccurate, content illustrating facts may be presented. For example, assume the brand being commented upon does not do animal testing. The system may then provide the user with a video illustrating how testing is performed in order to alter the negative opinion the user has of the brand. Similarly, if the comment was a question, such as “How do I do x?”, the system may provide videos or other content around that function. In a third example, the user states “I love this product.” In response, the system may provide content of the next version of the product. Conversely, if the user states “I hate this product”, the system may instead provide content of the product (or brand's) best feature. It is possible to analyze for Sentiment, Content and Context to build the profile and display appropriate content.

After the profile has been updated, it is again analyzed for the probability of achieving the desired result (at 606) in a manner similar to that discussed above. Returning to FIG. 4, the system determines if the user's sentiment is positive (at 416), and if so, maintains the content and awaits further user feedback. However, if the user reacts negatively to the content, then the system may select alternative content (at 418) using the updated psychological profile and probabilities.

In this manner, the system may build out a robust psychological profile for the user and leverage the profile to maximize the chance that content will have a desired result. If the system receives a negative feedback from the user, the profile is updated, and the content reviewed for alternatives. This ensures the user is consistently provided relevant and desirable content.

Further, by utilizing a cookie tied to the user's ID, the system is able to track the user across different content providers' platforms. Thus, comments on a Facebook page may bolster the user's psychological profile and alter the content the user may experience on an entirely different portal, such as YouTube.

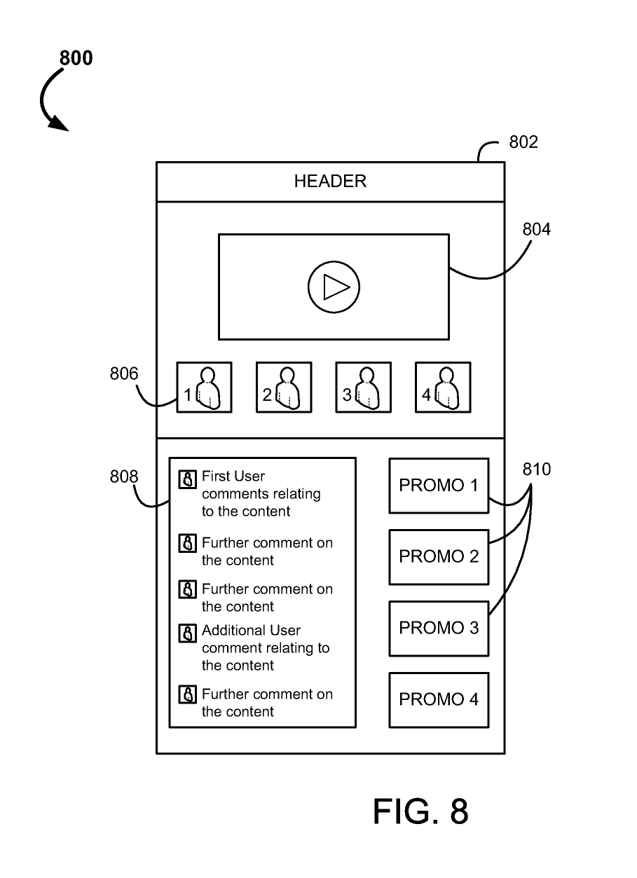

FIG. 8 is an example screenshot 800 of a channel webpage in which the automated channel addition system may be employed, in accordance with some embodiments. In this example screenshot, a header 802 is displayed, below which a primary content 804 is presented. Alternate content 810 is highlighted in a sidebar in this example. This example screen also includes a comments section 806. The users are displayed in thumbnails 808. The system logs the users' activity on the page. In some embodiments, a table of activities may be generated in the following format:

| | | Content | | | | | |
|---|---|---|---|---|---|---|---|
| Us- | | De- | User | | | | |
| er | Date/ | scrip- | Ac- | | Facebook | | Twitter |
| ID | Time | tion | tion | Object | ID | • • • | ID |
| 1 | 9-13 | Brand 1 | Media | 2 | Stacy2012 | • • • | |
| | 11:00 | | View | | | | |
| 1 | 9-14 | Brand 1 | Com- | Stop | | • • • | Smiller8 |
| | 12:32 | | ment | testing | | | |
| | | | | on | | | |
| | | | | animals | | | |
| 1 | 9-14 | Brand 2 | Show | 4 | Stacy2012 | • • • | |
| | 2:43 | | times | | | | |
| 2 | 8-29 | Brand 1 | Media | 2 | MerryMan | • • • | |
| | 9:02 | | View | | | | |

As can be seen in the example table, each user is given a user ID (persistent identification) that is independent from other content provider IDs. While the table is illustrated as including Facebook and Twitter, typical data sets will include a very large number of channels, where the user's ID can be associated with an ID native to each channel.

Using this example table's dataset, a user ID number 1 was recorded viewing a Brand 1 media clip on September 13^{th} on her Facebook account. The same user then posted a comment on Twitter on September 14 stating “Stop testing on animals.” Sentiment analysis on the comment determines that this user has reacted badly to the content displayed on Facebook, and alternate content may be selected for display to the user. This sentiment analysis may be performed upon subsequent page loading, or may be performed instantly once a negative sentiment is received. In this way, it may be possible to replace offending content as rapidly as possible in order to protect the advertisers, and also to maintain user satisfaction. Below the process for reprogramming content on the social networks 104a to 104n, and other content providers, will be described in greater detail.

Returning to FIG. 3, after the content has been selected, the system may publish the selected content to the channel (at 312). This publishing step utilizes the form data provided by the social network, or other channel, to tailor the content to that channels API.

Optionally, a further step may be performed (not illustrated) in which the system determines payment to the channel for prompting its users to engage with the marketing platform. Currently, when advertisers manually connect to social networks, the advertisers do not pay the social network for access to the social networks users. However, since the social network (or other channel) needs to initially request connection and provide their site for appraisal, a cost per engagement model may be employed to incentivize active participation by social networks.

This system and process for automated channel addition may be the first, ideal application for cost per engagement remuneration. Ultimately, what this system delivers to the advertisers is the engagement of social network users. A cost per engagement pricing model ensures that there is payment to the social network only if there is actual, measured engagement. Thus, with automated channel addition, advertiser motivation matches precisely what the social network actually delivers.

Another reason why automated channel addition may be the ideal application for cost per engagement is that via automated channel addition, the content management system is the entity that directly captures and records the engagement activity of social media users, including comments, “likes”, “sharing” etc. Since the content management system is a third party between the advertiser and the channel, there is no incentive for the content management system to inflate or deflate the recorded engagement metrics.

As an alternative to or in parallel with cost per engagement compensation, the content management system could provide a gamification experience for these smaller channels that connect with the platform in the way disclosed herein. In this gamified experience, these social networks would compete for badges, rankings on leaderboards and such in order to get favored placement by the platform in front of the advertisers.

### IV. System Embodiments

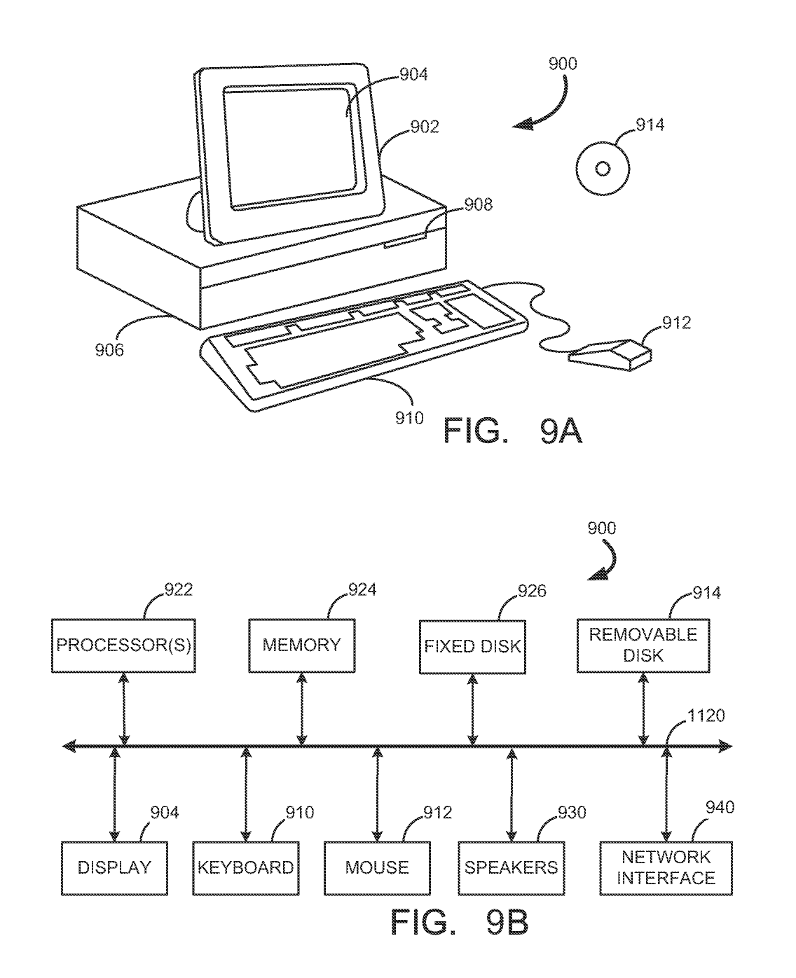

FIGS. 9A and 9B illustrate a Computer System 900, which is suitable for implementing embodiments of the present invention. FIG. 9A shows one possible physical form of the Computer System 900. Of course, the Computer System 900 may have many physical forms ranging from a printed circuit board, an integrated circuit, and a small handheld device up to a huge super computer. Computer system 900 may include a Monitor 902, a Display 904, a Housing 906, a Disk Drive 908, a Keyboard 910, and a Mouse 912. Disk 914 is a computer-readable medium used to transfer data to and from Computer System 900.

FIG. 9B is an example of a block diagram for Computer System 900. Attached to System Bus 920 are a wide variety of subsystems. Processor(s) 922 (also referred to as central processing units, or CPUs) are coupled to storage devices, including Memory 924. Memory 924 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A Fixed Disk 926 may also be coupled bi-directionally to the Processor 922; it provides additional data storage capacity and may also include any of the computer-readable media described below. Fixed Disk 926 may be used to store programs, data, and the like and is typically a secondary storage medium (such as a hard disk) that is slower than primary storage. It will be appreciated that the information retained within Fixed Disk 926 may, in appropriate cases, be incorporated in standard fashion as virtual memory in Memory 924. Removable Disk 914 may take the form of any of the computer-readable media described below.

Processor 922 is also coupled to a variety of input/output devices, such as Display 904, Keyboard 910, Mouse 912 and Speakers 930. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, motion sensors, brain wave readers, or other computers. Processor 922 optionally may be coupled to another computer or telecommunications network using Network Interface 940. With such a Network Interface 940, it is contemplated that the Processor 922 might receive information from the network, or might output information to the network in the course of performing the above-described multi-merchant tokenization. Furthermore, method embodiments of the present invention may execute solely upon Processor 922 or may execute over a network such as the Internet in conjunction with a remote CPU that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher level code that are executed by a computer using an interpreter.

In sum, the present invention provides systems and methods for automated channel addition. Such systems and methods enable advertisers to access a much wider variety and larger number of channels, such as social networks, without significant resource expenditure. Likewise, such systems enable social networks, or other channels, to access a wide variety of content (both advertisements and other marketing content) which may be of interest to the users of the channel. Moreover, the current automated channel adder can work in conjunction with sentiment based content selection and/or distributed engagement channels to further increase the utility of such a system.

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention.

It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A method for automated channel addition, useful in association with a content management system, the method comprising:
receiving a request for channel assessment;
scoring the channel by at least one of number of users, topics of conversations, sentiment of the topics, and level of engagement for the users;
cataloging the channel score for access by a client;
receiving approval of the channel from the client;
selecting content for the channel; and
publishing the selected content to the channel.

2. The method of claim 1, wherein the request for channel assessment includes an Atom XML or JSON file, or any other data representation format.

3. The method of claim 2, wherein the publishing the selected content to the channel uses the JSON or Atom XML file to modify the content to be compatible with the channel application programming interface.

4. The method of claim 1, wherein the scoring generates a composite score of number of users, topics of conversations, sentiment of the topics, and level of engagement for the users.

5. The method of claim 1, wherein the scoring generates multiple scores across a plurality of topic areas.

6. The method of claim 1, wherein the selecting content for the channel is selected in response to a channel request for particular content.

7. The method of claim 1, wherein the selecting content for the channel is selected in response to a client request for the particular channel.

8. The method of claim 1, wherein the selecting content for the channel further comprises:
identifying a desired result;
accessing a psychological profile that includes a persistent user identification, wherein the persistent user identification enables access to the psychological profile across a plurality of channels; and
selecting content by maximizing probabilities of the desired result occurring based upon the psychological profile.

9. The method of claim 8, further comprising collecting feedback by the user to the selected content, further comprising collecting feedback by the user to the selected content, and re-selecting content by maximizing probabilities of the desired result occurring based upon the updated psychological profile.

10. The method of claim 8, wherein the persistent user identification is stored locally with the user as a cookie, browser storage, or other form of local storage.

11. A content management system for automated channel addition comprising:
a server configured to receive a request for channel assessment;
a channel assessor configured to score the channel by at least one of number of users, topics of conversations, sentiment of the topics, and level of engagement for the users;
a database configured to catalog the channel score for access by a client;
an interface configured to receive approval of the channel from the client;
a content selector configured to select content for the channel; and
the server further configured to publish the selected content to the channel.

12. The system of claim 11, wherein the request for channel assessment includes a JSON or Atom XML file.

13. The system of claim 12, wherein the server uses the JSON or Atom XML file to modify the content to be compatible with the channel application programming interface.

14. The system of claim 11, wherein the channel assessor generates a composite score of number of users, topics of conversations, sentiment of the topics, and level of engagement for the users.

15. The system of claim 11, wherein the channel assessor generates multiple scores across a plurality of topic areas.

16. The system of claim 11, wherein the content selector selects the channel in response to a channel request for particular content.

17. The system of claim 11, wherein the content selector selects the channel in response to a client request for the particular channel.

18. The system of claim 11, wherein the content selector selects the channel by performing the steps of:
identifying a desired result;
accessing a psychological profile that includes a persistent user identification, wherein the persistent user identification enables access to the psychological profile across a plurality of channels; and
selecting content by maximizing probabilities of the desired result occurring based upon the psychological profile.

19. The system of claim 18, wherein the content selector further performs the steps of collecting feedback by the user to the selected content, further comprising collecting feedback by the user to the selected content, and re-selecting content by maximizing probabilities of the desired result occurring based upon the updated psychological profile.

20. The system of claim 18, wherein the persistent user identification is stored locally with the user as a cookie, browser storage, or other form of local storage.
